(19) United States
(12) Patent Application Publication
(10) Pub. No.: US 2009/0135297 A1
(43) Pub. Date: May 28, 2009

(54) CAMERA MODULE

(75) Inventors: YING-CHENG WU, Tu-Cheng (TW); PANG-JUNG LIU, Tu-Cheng (TW); CHIEN-CHENG YAO, Tu-Cheng (TW); SHIH-MIN LO, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/019,914

(22) Filed: Jan. 25, 2008

(30) Foreign Application Priority Data
Nov. 26, 2007 (CN) 200710202669.9

(51) Int. Cl. H04N 5/225; G03B 17/02

(52) U.S. Cl. 348/374; 396/535; 348/E05.024

(57) ABSTRACT

An exemplary camera module includes a substrate, a printed circuit board, an imaging sensor chip, and a lens module. The substrate defines a top surface and a recessed portion in the top surface. The printed circuit board defines a bottom surface soldered to the top surface of the substrate. The imaging sensor chip is received in the recessed portion of the substrate. The lens module is positioned above the imaging sensor chip, with an optical center thereof aligned with that of the imaging sensor chip.

### BACKGROUND

1. Technical Field

The present invention relates to imaging technology and, particularly, to an camera module having a compact configuration.

2. Description of Related Art

A camera module generally comprises a printed circuit board (PCB), a lens module, an imaging sensor chip, a substrate, and a support. The PCB used in a camera module is generally a flexible PCB. The lens module comprises a lens barrel, lenses carried within the lens barrel, and a housing for housing the lens barrel and the imaging sensor chip therein. The imaging sensor chip and the lens module are mounted on the substrate. The flexible PCB must bear the substrate, the imaging sensor chip, and the lens module thereon. Apparently, the substrate, the imaging sensor chip, and the lens module are considerably weighty relative to a capability of the flexible PCB, thus the support is disposed beneath the PCB for reinforcement. This increases a depth of the camera module.

What is needed, therefore, is a camera module which has a compact configuration.

### SUMMARY

According to a present embodiment, a camera module includes a substrate, a printed circuit board, an imaging sensor chip, and a lens module. The substrate defines a top surface and a recessed portion in the top surface. The printed circuit board defines a bottom surface soldered to the top surface of the substrate. The imaging sensor chip is received in the recessed portion of the substrate. The lens module is positioned above the imaging sensor chip, with an optical center thereof aligned with that of the imaging sensor chip.

Other advantages and novel features will be drawn from the following detailed description of at least one embodiment, when considered in conjunction with the attached drawings.

### BRIEF DESCRIPTION OF THE DRAWINGS

FIG. 1 is a cross-sectional view of a camera module, according to a first embodiment.

FIG. 2 is an isometric view of an assembly of a substrate and a printed circuit board of the camera module of FIG. 1.

FIG. 3 is a cross-sectional view of a camera module, according to a second embodiment.

### DETAILED DESCRIPTION OF THE EMBODIMENTS

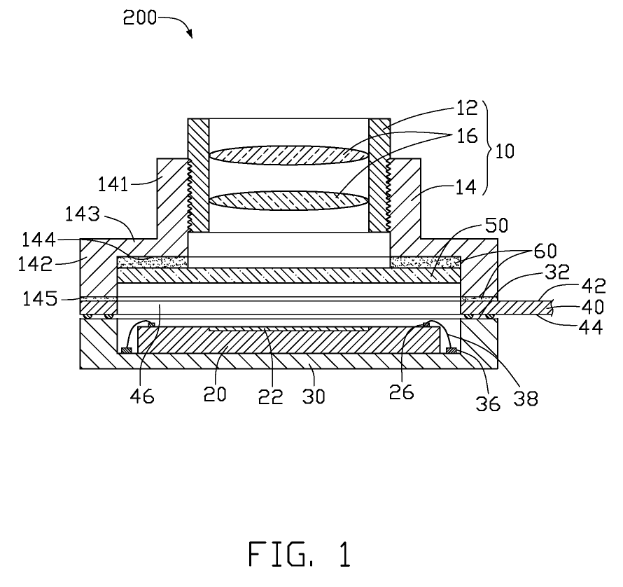

Referring to FIG. 1, a camera module 200 according to a first embodiment is illustrated. The camera module 200 comprises a lens module 10, and an imaging sensor chip 20, a substrate 30, and a printed circuit board (PCB) 40. The substrate receives the imaging sensor chip 20 therein and supports the lens module 10 and the PCB 40 thereon.

The lens module 10 comprises a lens barrel 12, a housing 14, and lenses 16. The housing 14 comprises a hollow top portion 141, a hollow bottom portion 142 coaxially aligned with the hollow top portion 141, and a connecting plate 143 connecting the top and bottom portions 141, 142. The top portion 141 is smaller than the bottom portion 142. The lenses 16 are received in the lens barrel 12, and the combined lens barrel 12 and lenses 16 are received in the top portion 141 of the housing 14. The connecting plate 143 comprises a bottom surface 144. A transparent plate 50 is received in the bottom portion 142 and is secured to the bottom surface 144 of the connecting plate 143 by adhesive 60. The bottom portion 142 comprises a bottom surface 145, which is a bottom extremity of the lens module 10.

The imaging sensor chip 20 comprises a central sensing portion 22, and a plurality of soldering pads 26 surrounding the central sensing portion 22. Optical centers of the imaging sensor chip 20 and the lens module 10 are aligned with each other.

The substrate 30 defines a top surface 32, a central recessed portion 34 defined in the top surface 32. The imaging sensor chip 20 is received in the recessed portion 34. The lens module 10 is adhered to the PCB 40, and disposed above the imaging sensor chip 20. A plurality of soldering pads 36 is arranged in the recessed portion 34 and is connected to the soldering pads 26 by wires 38.

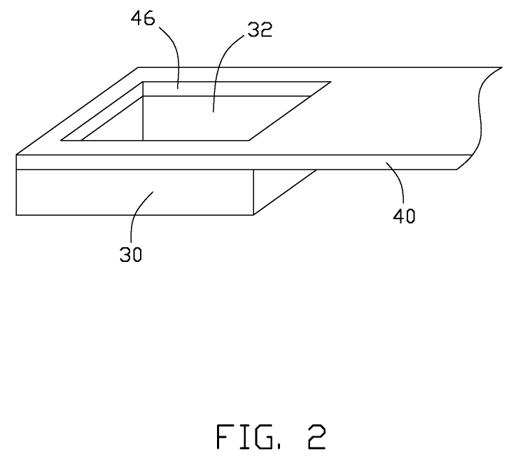

The PCB 40 comprises a top surface 42 adhered to the bottom surface 145 of the housing 14 by adhesive 60, and a bottom surface 44 soldered to the top surface 32 of the substrate 30. The PCB 40 defines an opening 46 (see FIG. 2) extending through the top and bottom surfaces 42, 44 and aligned with the recessed portion 34 of the substrate 30. The opening 46 is large enough to expose the imaging sensor chip 20 to the bottom portion 142 of the housing 14, so that light entering the camera module 200 can be received by the imaging sensor chip 20.

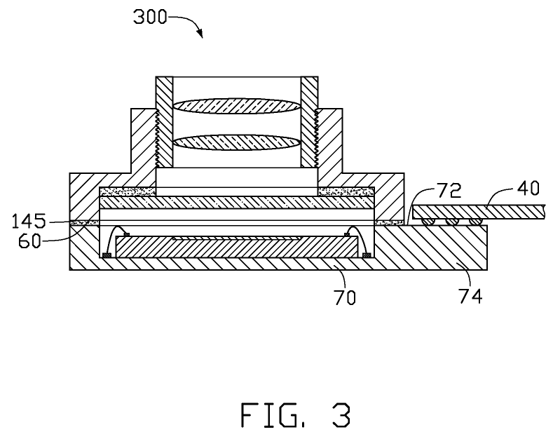

Referring to FIG. 3, a camera module 300 according to a second embodiment is illustrated. The camera module 300 is similar to the camera module 200. However, a substrate 70 forms a stretched portion 74 extending from a side thereof and defines a top surface 72. The bottom surface 145 of the housing 14 is adhered to the top surface 72 of the substrate 70 by the adhesive 60. The PCB 40 is soldered to the top surface 72 at the stretched portion 74 of the substrate 70.

In the embodiments, the PCB 40, the lens module 10, and the imaging sensor chip 20 are disposed at a same side of the substrate 20/70. The substrate 20/70 is used to bear the lens module 10 and the imaging sensor chip 20 thereon and to reinforce the PCB 40. Thus, the support as described in the BACKGROUND can be omitted, and the camera modules 200, 300 become compact.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A camera module comprising:
a substrate defining a top surface and a recessed portion defined in the top surface;
a printed circuit board defining a bottom surface soldered to the top surface of the substrate;
an imaging sensor chip received in the recessed portion; and
a lens module positioned above the imaging sensor chip, with an optical center thereof aligned with that of the imaging sensor chip.

2. The camera module as claimed in claim 1, wherein the lens module defines a bottom surface secured to a top surface of the printed circuit board.

3. The camera module as claimed in claim 2, wherein the bottom surface of the lens module is adhered to the top surface of the printed circuit board by adhesive.

4. The camera module as claimed in claim 2, wherein the printed circuit board defines an opening extending through the top and bottom surface thereof and aligned with the recessed portion of the substrate, and wherein the opening is large enough to expose the imaging sensor chip to the lens module.

5. The camera module as claimed in claim 1, wherein a plurality of soldering pads are formed on the imaging sensor chip and in the recessed portion of the substrate, and wherein a plurality of wires connect the soldering pads on the imaging sensor chip to the soldering pads in the substrate respectively.

6. The camera module as claimed in claim 1, wherein the lens module defines a bottom surface secured to the top surface of the substrate.

7. The camera module as claimed in claim 6, wherein the bottom surface of the lens module is adhered to the top surface of the substrate by adhesive.

8. The camera module as claimed in claim 6, wherein the substrate forms a stretched portion extending from a side thereof, and wherein the bottom surface of the printed circuit board is soldered to the top surface at the stretched portion of the substrate.
